(19) United States
(12) Patent Application Publication
(10) Pub. No.: US 2005/0038814 A1
(43) Pub. Date: Feb. 17, 2005

(54) Method, apparatus, and program for cross-linking information sources using multiple modalities

(75) Inventors: Giridharan R. Iyengar, Mahopac, NY (US); Chalapathy Venkata Neti, Yorktown Heights, NY (US); Harriet Jane Nock, Elmsford, NY (US)

Correspondence Address: DUKE. W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/640,894

(22) Filed: Aug. 13, 2003

(51) Int. Cl. G06F 7/00

(52) U.S. Cl. 707/104.1

(57) ABSTRACT

A mechanism is provided for cross-linking information sources using multiple modalities. Text documents, images, audio sources, video, and other media are analyzed to determine media descriptors, which are metadata describing the content of the media sources. The media descriptors from all modalities are collated and cross-linked. A query processing and presentation module, which receives queries and presents results, may also be provided. A query may consist of textual keywords from user input. Alternatively, a query may derive from a media source, such as a text document, image, audio source, or video source.

### BACKGROUND OF THE INVENTION

1. Technical Field

The present invention relates to data processing systems and, in particular, to cross-linking information sources for search and retrieval. Still more particularly, the present invention provides a method, apparatus, and program for cross-linking information sources using multiple modalities.

2. Description of Related Art

A personal computer (PC) is a general purpose microcomputer that is relatively inexpensive and ideal for use in the home or small office. Personal computers may range from large desktop computers to compact laptop computers to very small, albeit powerful, handheld computers. Typically, personal computers are used for many tasks, such as information gathering, document authoring and editing, audio processing, image editing, video production, personal or small business finance, electronic messaging, entertainment, and gaming.

Recently, personal computers have evolved into a type of media center, which stores and plays music, video, image, audio, and text files. Many personal computers include a compact disk (CD) player, a digital video disk (DVD) player, and MPEG Audio Layer 3 (MP3) audio compression technology. In fact, some recent personal computers serve as digital video recorders for scheduling, recording, storing, and categorizing digital video from a television source. These PCs may also include memory readers for reading non-volatile storage media, such as SmartMedia or CompactFlash, which may store photographs, MP3 files, and the like.

Personal computers may also include software for image slideshows and video presentation, as well as MP3 jukebox software. Furthermore, peer-to-peer file sharing allows PC users to share songs, images, and videos with other users around the world. Thus, users of personal computers have many sources of media available, including, but not limited to, text, image, audio, and video.

### SUMMARY OF THE INVENTION

Understandably, the number of media channels available to a computer user may become overwhelming, particular for the casual or inexperienced computer user. The volume of information that is accessible makes it very difficult for consumers to efficiently find specific and, in some cases, crucial information. To combat the information overload, search engines, catalogs, and portals are provided. However, the approaches of the prior art focus only on textual content or media content for which a textual description or abstract exists. Other efforts focus on embedding tags in content so that information having multiple modalities may be machine readable. However, annotating the vast amount of available media content to arrive at these tags would be a daunting task.

Therefore, a mechanism is provided for cross-linking information from multiple modalities. Text documents, images, audio sources, video, and other media are analyzed to determine media descriptors, which are metadata describing the content of the media sources. The media descriptors from all modalities are collated and cross-linked. The mechanism may also provide a query processing and presentation module, which receives queries and presents results. A query may consist of textual keywords from user input. A query may derive from a media source, such as a text document, image, audio source, or video source.

### BRIEF DESCRIPTION OF THE DRAWINGS

The exemplary aspects of the present invention will best be understood by reference to the following detailed description when read in conjunction with the accompanying drawings, wherein:

FIG. 1 depicts a pictorial representation of an exemplary network of data processing systems in which the exemplary aspects of the present invention may be implemented;

FIG. 2 is a block diagram of an exemplary data processing system that may be implemented as a server in accordance with exemplary aspects of the present invention;

FIG. 3 is a block diagram illustrating an exemplary data processing system in which exemplary aspects of the present invention may be implemented;

FIGS. 4A-4D are block diagrams illustrating exemplary mechanisms for media translation and analysis in accordance with exemplary aspects of the present invention;

FIG. 5 depicts a block diagram of an exemplary multiple modality cross-linking data processing system in accordance with exemplary aspects of the present invention;

FIGS. 6A-6D are flowcharts illustrating the operation of media specific translation and analysis in accordance with exemplary aspects of the present invention;

FIG. 7 is a flowchart illustrating the operation of an exemplary collation and analysis mechanism in accordance with exemplary aspects of the present invention; and

FIG. 8 is a flowchart illustrating the operation of an exemplary query processing and presentation module in accordance with exemplary aspects of the present invention.

### DETAILED DESCRIPTION OF THE ILLUSTRATIVE EMBODIMENTS

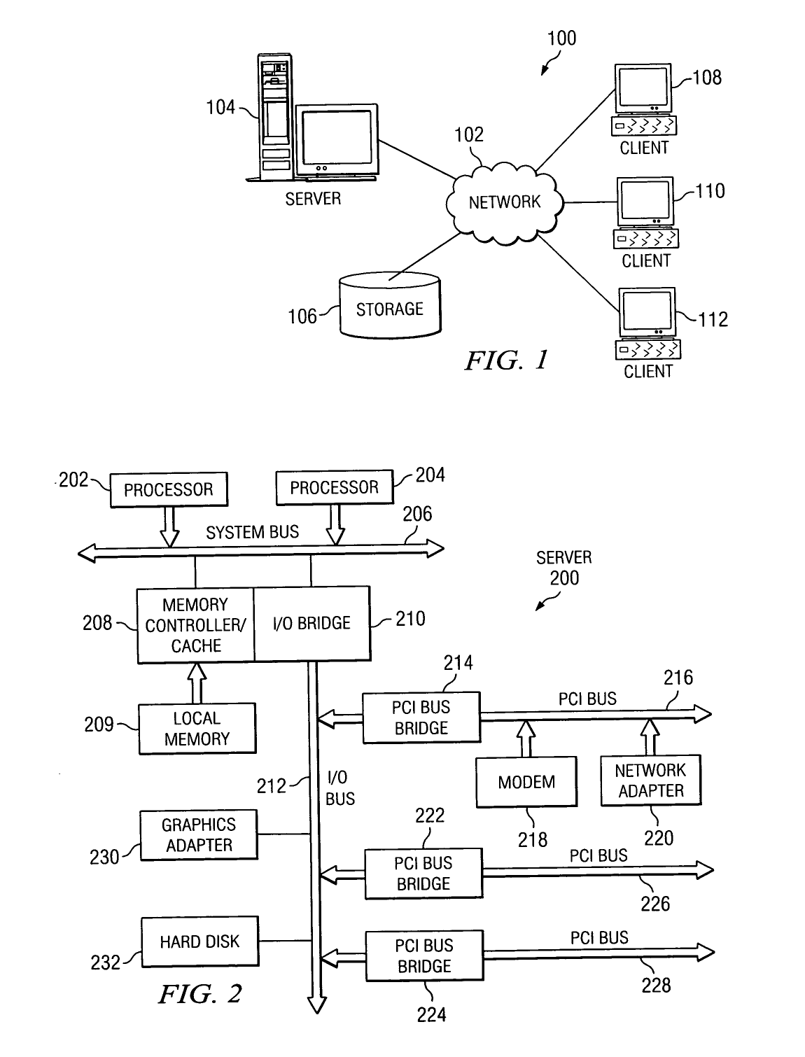

With reference now to the figures, FIG. 1 depicts a pictorial representation of an exemplary network of data processing systems in which the exemplary aspects of the present invention may be implemented. Network data processing system 100 is a network of computers in which the exemplary aspects of the present invention may be implemented. Network data processing system 100 contains, for example, a network 102, which is the medium used to provide communications links between various devices and computers connected together within network data processing system 100. Network 102 may include connections, such as, for example, wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with exemplary aspects of the present invention, server 104 may provide media content to clients 108, 110, 112. For example, server 104 may be Web server or database server. As another example, server 104 may include a search engine providing references to media content. Server 104 may also provide a portal, which is a starting point or home page for users of Web browsers. The server may perform analysis of the media content to determine media descriptors and cross-linking of the media sources. Thus, the server may provide access to not only text or hypertext markup language (HTML) content, but also to audio, image, video, and other media content.

For example, responsive to a search request about a sports celebrity, server 104 may provide results including newspaper or magazine articles, streaming video of recent game highlights, and streaming audio of press conferences. While a prior art portal server may provide links to recent news stories, the server may cross-link these stories to image, audio, and video content. For example, a news story about a tropical storm may be cross-linked with satellite images. A news story about an arrest may be cross-linked with photographs of the suspect. As yet another example, a story covering the death of a famous actor may be cross-linked with a movie clip.

Thus, the server may include references to content that may not be discoverable by analyzing content in only one modality. For example, a newspaper source may describe an event in a different manner than a television report of the same event. The television report may be more sensationalized or may include video footage or sound. In fact, a variety of newspaper sources reporting on an event may use vastly different words to be considered related to each other based purely on textual analysis. Likewise, a variety of images from a single event may be difficult to cross-link, based only on the visual content because of different camera viewpoints, different times of day, etc. However, images, speech, and voices, as well as textual context, may provide strong clues on the relationships between media channels and, therefore, may be used to cross-link media sources.

A client may perform analysis of the media content to determine media descriptors and cross-linking of the media sources. Recently, personal computers have evolved into a type of media center, which stores and plays music, video, image, audio, and text files. Many personal computers include a compact disk (CD) player, a digital video disk (DVD) player, and MPEG Audio Layer 3 (MP3) audio compression technology, for example. In fact, some recent personal computers serve as digital video recorders for scheduling, recording, storing, and categorizing digital video from a television source. These PCs may also include memory readers for reading non-volatile storage media, such as SmartMedia or CompactFlash, for example, which may store photographs, MP3 files, and the like. As such, clients 108-112 may collect media from many sources and media types. The number of photographs, songs, audio files, video files, news articles, cartoons, stories, jokes, and other media content may become overwhelming.

In accordance with exemplary aspects of the present invention, collation and analysis modules may analyze media received at a client to determine media descriptors and metadata and to cross-link the media sources. Thus, the client may present media of one modality and a query processing and presentation module may suggest media of the same modality or a different modality. For example, a user may listen to a song by a particular singer and the collation and analysis modules may use voice recognition to identify the individual. The collation and analysis modules may also perform image analysis on a movie, which was digitally recorded from a television source, to identify actors in the movie. The query processing and presentation module may determine that the identified singer also appeared in the movie and, thus, suggest the disparate media sources as being related.

The client may have collation and analysis modules for identifying media descriptors and metadata. These descriptors may be sent to a third party, such as server 104, for cross-linking. The server may then collect these descriptors and reference the media sources. When a client reports a particular media source and a related media source exists, the server may notify the client of the related media through, for example, an instant messaging service. The client may then receive instant messages from the server and present the messages to the user. For example, the collation and analysis modules at a client may identify the voice of a speaker in an audio stream and the server may suggest a recent newspaper article about the speaker or a photograph. As another example, the collation and analysis modules at the client may identify the facial features of a politician in a video stream and the server may suggest famous speeches by the politician.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the present invention.

Referring to FIG. 2, a block diagram of an exemplary data processing system that may be implemented as a server, such as server 104 in FIG. 1, is depicted in accordance with exemplary aspects of the present invention. Data processing system 200 may be, for example, a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system, for example.

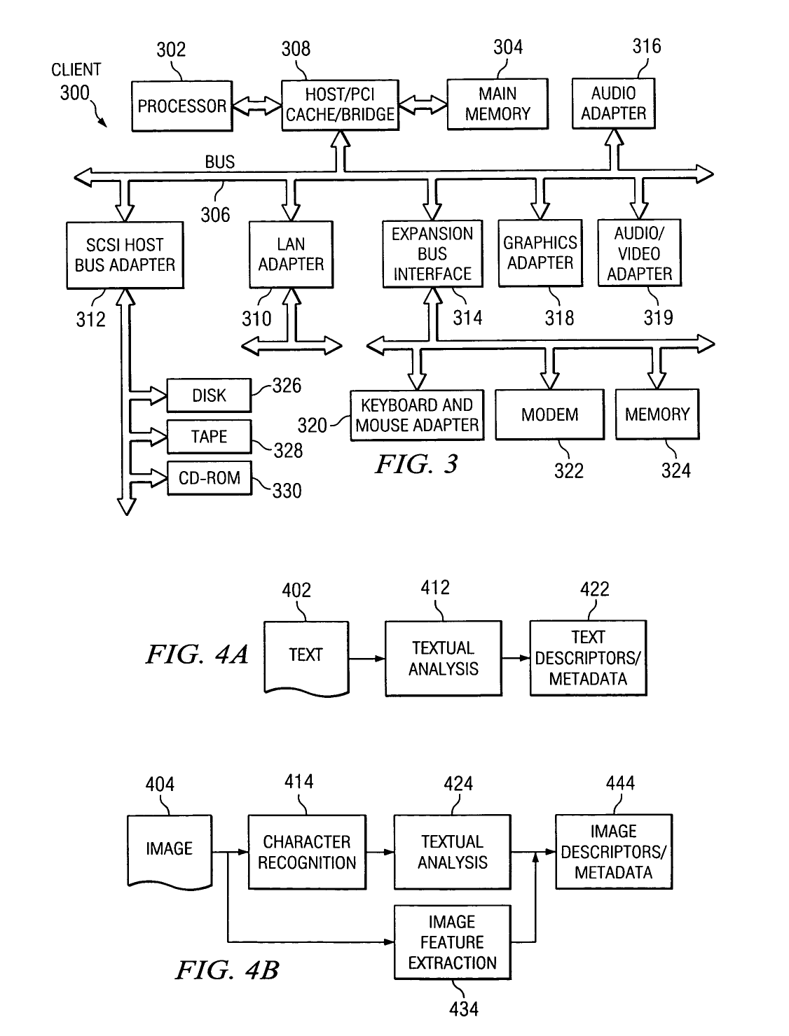

With reference now to FIG. 3, a block diagram illustrating an exemplary data processing system is depicted in which the exemplary aspects of the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319, for example, are connected to PCI local bus 306 by add-in boards inserted into expansion slots. Expansion bus interface 314 provides a connection for a keyboard and mouse adapter 320, modem 322, and additional memory 324, for example. Small computer system interface (SCSI) host bus adapter 312 provides a connection for hard disk drive 326, tape drive 328, and CD-ROM drive 330, for example. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, for example, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, for example, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA, for example. Data processing system 300 also may be a kiosk or a Web appliance.

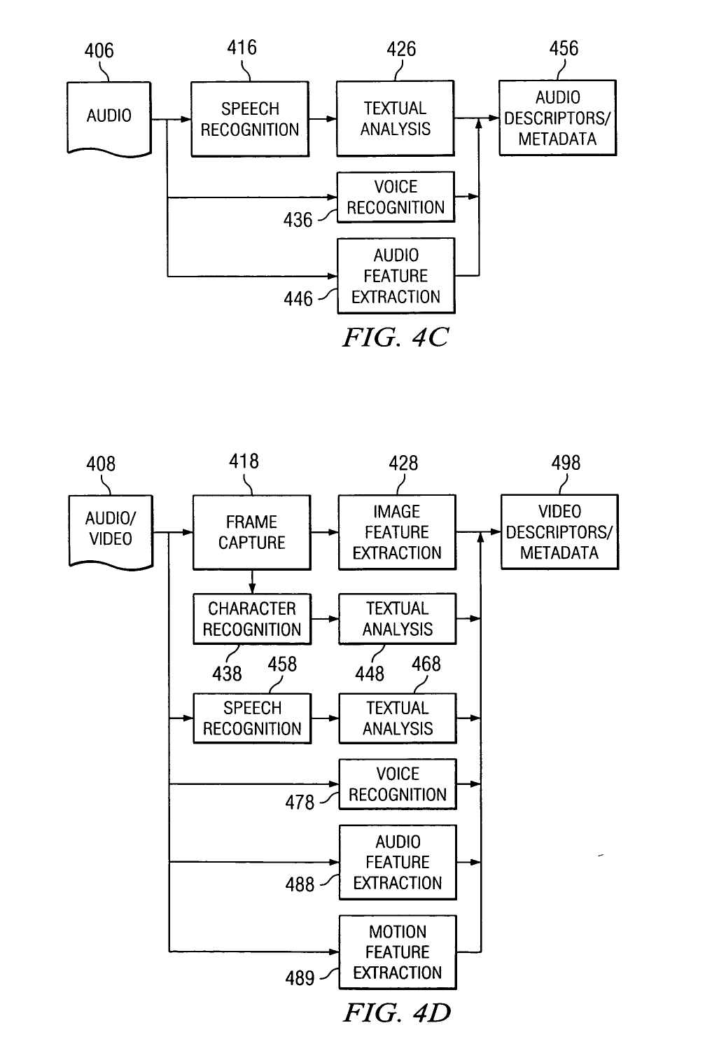

With reference to FIGS. 4A-4D, block diagrams illustrating exemplary mechanisms for media translation and analysis are shown in accordance with exemplary aspects of the present invention. More particularly, FIG. 4A depicts translation and analysis for a text media source. Text document 402 is received as a media source. Textual analysis module 412 may perform known techniques for content analysis, such as keyword extraction, natural language processing, language translation, and the like. The textual analysis module generates text descriptors 422 for source text 402. These text descriptors provide metadata for the content of the text document.

With reference now to FIG. 4B, image 404 is received as a media source. Character recognition module 414 may perform optical character recognition techniques in a known manner to identify textual content within image 404. As an example, image 404 may be a photograph with a caption and character recognition module 414 may extract the textual content from the caption. Further examples of textual content within an image source may include product logos or names, for instance an airplane with an airline name on the side, text appearing on a sign such as a billboard or picket sign, a weather map with city or state names, or a photograph taken at a sporting event that includes a team or player name. Textual analysis module 424 may perform known techniques for content analysis, such as keyword extraction, natural language processing, language translation, and the like. The textual analysis module generates descriptors, which provide metadata for the content of image 404.

Image feature extraction module 434 may perform image analysis on image 404 to identify image features. Image feature extraction module 434 may perform pattern recognition, as known in the art, to recognize shapes, identify colors, determine perspective, or to identify facial features and the like. For example, the image feature extraction module may analyze image 404 and identify a constellation, a well-known building, or a map of the state of New York. The image feature extraction module generates descriptors, which provide metadata for the content of image 404 in addition to those generated by textual analysis module 424.

Together, the image descriptors 444 provide a thorough account of the content of an image. For example, image 404 may be a photograph of an airplane. The caption may mention the word “crash” and a city name. The character recognition module may extract the caption information, as well as an airline name from the side of the airplane. The image feature extraction module may recognize the image of an airplane and smoke coming from an engine. All these clues provide a more accurate description of the image than a caption alone.

Turning now to FIG. 4C, audio 406 is received as a media source. Speech recognition module 416 may perform speech recognition techniques, such as pattern recognition, in a known manner to identify textual content within audio 406. As an example, image 406 may be a song and speech recognition module 416 may extract the lyrics of the song. Further examples of textual content within an audio source may include product names in radio advertisements, a press conference, or a news broadcast. Textual analysis module 426 may perform known techniques for content analysis, such as keyword extraction, natural language processing, language translation, and the like. The textual analysis module generates descriptors, which provide metadata for the content of audio 406.

Voice recognition module 436 may perform audio feature analysis, as known in the art, to identify voice profiles of known individuals. For example, voice recognition module 436 may identify the voice of the President in a public address. Other examples may include the voice of an actor in an endorsement, the voice of a singer in a song, the voice of the Chief Operating Officer of a major corporation in a sound clip, or the voice of an athlete in a press conference. The voice recognition module generates descriptors, including information identifying a speaker, which provide metadata for the content of audio 406.

Audio feature extraction module 446 may perform audio analysis on audio 406 to identify audio features. Audio feature extraction module 446 may perform pattern recognition, as known in the art, to recognize various sounds, such as explosions, traffic, animal sounds, thunder, wind, and the like. For example, the audio feature extraction module may analyze audio 406 and identify the sound of a space shuttle launch, the crackling of a fire, applause, or a drum pattern. The audio feature extraction module generates descriptors, which provide metadata for the content of audio 406 in addition to those generated by textual analysis module 426 and voice recognition module 436.

When the descriptors generated by the textual analysis module, the voice recognition module, and the audio feature extraction module are combined to form audio descriptors 456, they provide a thorough account of the content of an audio source. For example, audio 406 may be a sound clip from a sports broadcast. The reporter may mention the term “league record.” The speech recognition module may extract this information. The voice recognition module may identify the speaker as a known baseball commentator. The audio feature extraction module may recognize the crack of a baseball bat hitting a baseball and the swell of applause. All these clues provide a more accurate description of the audio than a simple textual descriptor or file name.

With reference now to FIG. 4D, video 408 is received as a media source. Frame capture module 418 isolates frames of images from the video stream. Image feature extraction module 428 may perform image analysis on still images from video 408 to identify image features. Image feature extraction module 428 may perform pattern recognition, as known in the art, to recognize shapes, identify colors, determine perspective, or to identify facial features and the like. In addition, motion analysis between consecutive still images may be performed to extract motion attributes of objects in the image. For example, the image feature extraction module may identify the facial features of a political figure, a space shuttle, or a forest fire. The image feature extraction module generates descriptors, which provide metadata for the content of video 408.

Character recognition module 438 may perform optical character recognition techniques in a known manner to identify textual content within video 408. As an example, video 408 may be a news report about a parade and character recognition module 438 may extract the textual content from banners. Textual content may also be extracted, for example, from closed captioning or subtitle information. Textual analysis module 448 may perform known techniques for content analysis, such as keyword extraction, natural language processing, language translation, and the like. The textual analysis module generates descriptors, which provide metadata for the content of frames from video 408.

Speech recognition module 458 may perform speech recognition techniques, such as pattern recognition, in a known manner to identify textual content within audio channels in video 408. Textual analysis module 468 may perform known techniques for content analysis, such as keyword extraction, natural language processing, language translation, and the like. The textual analysis module generates descriptors, which provide metadata for the content of audio channels within video 408.

Voice recognition module 478 may perform audio feature analysis, as known in the art, to identify voice profiles of known individuals. The voice recognition module generates descriptors, including information identifying a speaker, which provide metadata for the content of video 408. Audio feature extraction module 488 may perform audio analysis on audio channels in video 408 to identify audio features. Audio feature extraction module 488 may perform pattern recognition, as known in the art, to recognize various sounds, such as explosions, traffic, animal sounds, thunder, wind, and the like. The audio feature extraction module generates descriptors, which provide metadata for the content of video 408 in addition to those generated by image feature extraction module 428, textual analysis modules 448, 468, and voice recognition module 478.

Motion feature extraction module 489 may perform motion feature analysis, as known in the art, to identify moving objects within the video source and the nature of this motion. For example, motion feature extraction module 489 may recognize the flight of an airplane, a running animal, the swing of a baseball bat, or two automobiles headed for a collision. The motion feature extraction module generates descriptors, which provide metadata for the content of video 408 in addition to those generated by image feature extraction module 428, textual analysis modules 448, 468, voice recognition module 478, and audio feature extraction module 488.

When the descriptors generated by the various modules are combined to form video descriptors 498, they provide a thorough account of the content of a video source. For example, video 408 may be a video clip from a news broadcast. The reporter may mention the words “fire” and “downtown.” The speech recognition module may extract this information. The audio feature extraction module may recognize the crackle of fire and the image feature extraction module may recognize a well-known skyscraper in a nearby city. All these clues provide a more accurate description of the video source than a simple textual descriptor or file name.

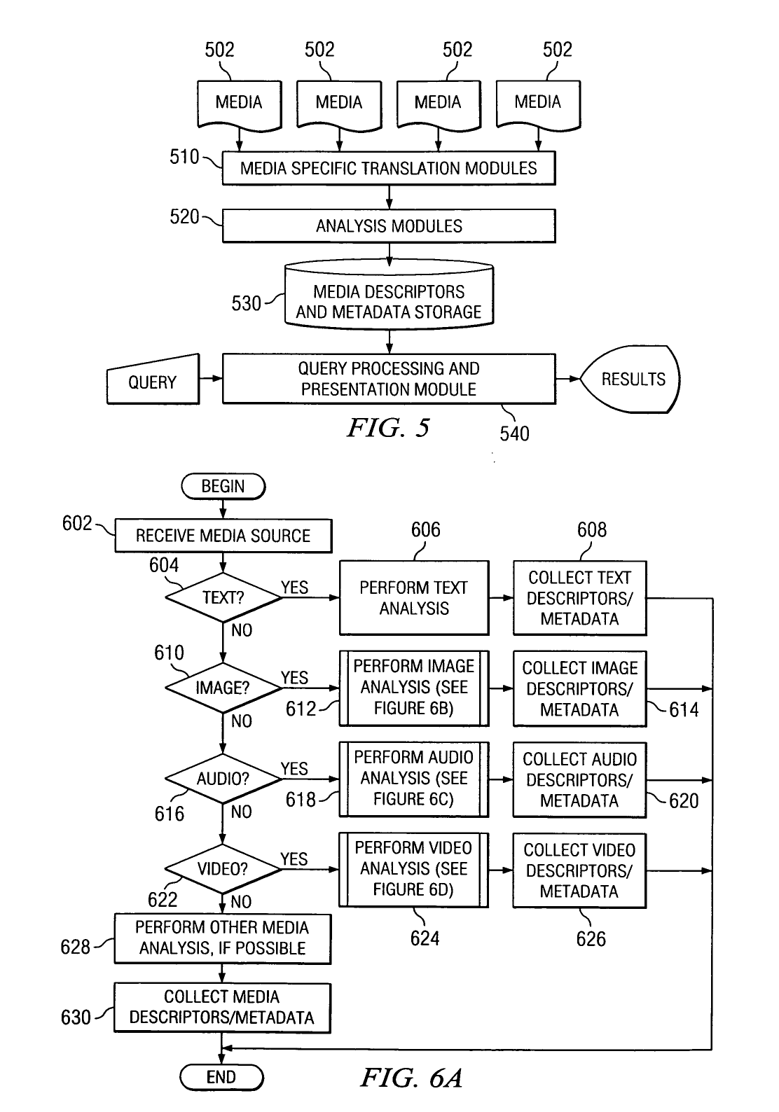

FIG. 5 depicts a block diagram of an exemplary multiple modality cross-linking data processing system in accordance with exemplary aspects of the present invention. Media sources 502 are received by the system. Media specific translation modules 510 perform translation functions, such as frame capture, character recognition, speech recognition, voice recognition, image feature extraction, and audio feature extraction. Media descriptors are collected and analyzed by analysis module 520. Then, metadata for media sources 502 are gathered into media descriptors and metadata storage 530.

Query processing and presentation module 540 receives queries for media and identifies matching media using media descriptors and metadata from storage 530. A query may consist of a simple keyword query statement using Boolean logic. Alternatively, a query may consist of a media source, such as a text document, audio stream, image, or video source. The query media source may be translated by media specific translation modules 510 and analyzed by analysis module 520 to form media descriptors. These media descriptors may be used to form a query. Results of the query may be presented to the requester.

The multiple modality cross-linking data processing system may be embodied in a stand alone computer, such as a client or server as shown in FIG. 1. Thus, a user may collect several disparate media sources and cross-link these sources to make them more manageable. A server may provide access to media sources 502 and cross-link these sources to provide a multiple modality search engine or portal. Thus, the data processing system shown in FIG. 5 may receive queries from clients and provide results to the requesting clients.

Alternatively, the multiple modality cross-linking data processing system shown in FIG. 5 may be employed within a distributed data processing system. Users of client computers may collect various media sources and the client computers may perform media specific translation and content analysis. The clients may then provide media descriptors to a server. The server may then inform users that related media is available from other clients or from a storage located at the server. In an exemplary embodiment, clients may provide media descriptors to other clients in a peer-to-peer environment. Then, other clients may provide related media based on the received media descriptors.

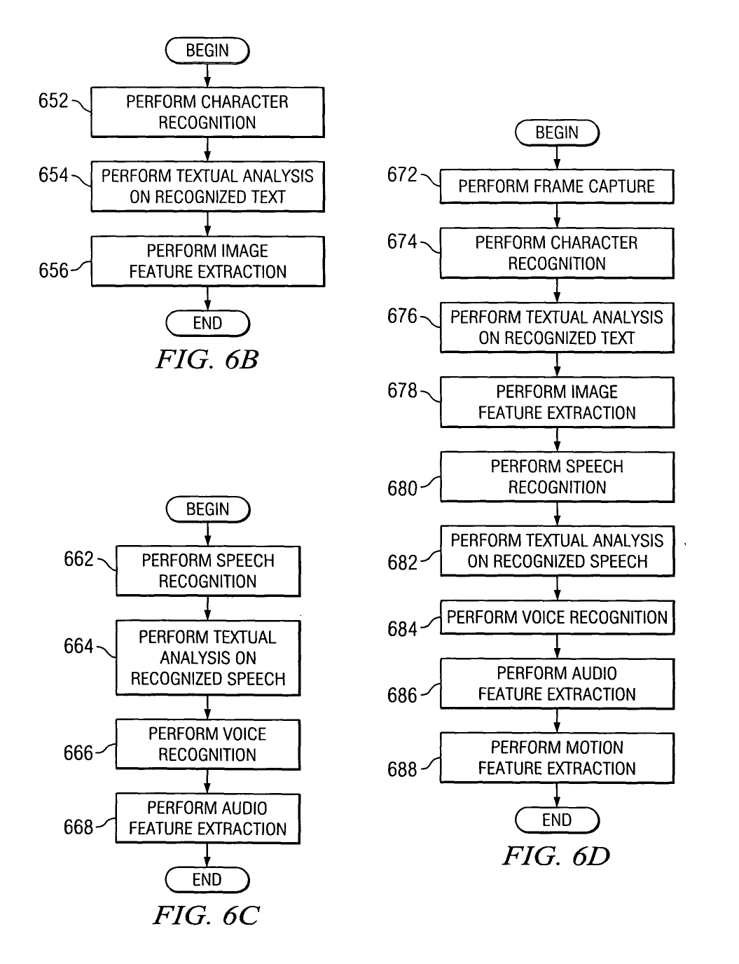

FIGS. 6A-6D are flowcharts illustrating the operation of exemplary media specific translation and analysis in accordance with exemplary aspects of the present invention. More specifically, with reference to FIG. 6A, the process begins and receives a media source (step 602). A determination is made as to whether the media source is a text source (step 604). If the media source is a text source, the process performs textual analysis (step 606) and collects text descriptors/metadata for the text source (step 608). Then, the process ends.

If the media source is not a text source in step 604, a determination is made as to whether the media source is an image source (step 610). If the media source is an image source, the process performs image analysis (step 612). The detailed operations of image analysis are described below with respect to FIG. 6B. Then, the process collects image descriptors/metadata for the image source (step 614) and ends.

If the media source is not an image source in step 610, a determination is made as to whether the media source is an audio source (step 616). If the media source is an audio source, the process performs audio analysis (step 618). The detailed operations of audio analysis are described below with respect to FIG. 6C. Then, the process collects audio descriptors/metadata for the audio source (step 620) and ends.

If the media source is not an audio source in step 616, a determination is made as to whether the media source is a video source (step 622). If the media source is a video source, the process performs video analysis (step 624). The detailed operations of video analysis are described below with respect to FIG. 6D. Then, the process collects video descriptors/metadata for the video source (step 626) and ends.

If, however, the media source is not a video source in step 622, the process performs other media analysis, if possible (step 628). Thereafter, the process collects media descriptors/metadata for the media source (step 630) and ends.

With reference to FIG. 6B, the operation of image analysis is illustrated. The process begins and performs character recognition on the image (step 652). Then, the process performs textual analysis on the recognized text (step 654). Thereafter, the process performs image feature extraction on the image (step 656) and the process ends.

Turning to FIG. 6C, the operation of audio analysis is shown. The process begins and performs speech recognition on the audio (step 662). Then, the process performs textual analysis on the recognized speech (step 664). The process performs voice recognition (step 666) and performs audio feature extraction on the audio source (step 668). Thereafter, the process ends.

FIG. 6D depicts the operation of video analysis. The process begins and performs frame capture to isolate still images within the video source (step 672). Then, the process performs character recognition on the captured frames (step 674). The process then performs textual analysis on the recognized text (step 676). The process also performs image feature extraction (step 678) on captured frames. Then, the process performs speech recognition (step 680) and performs textual analysis on the recognized speech (step 682). The process performs voice recognition (step 684), and audio feature extraction (step 686) on audio channels within the video source. The process also performs motion feature extraction (step 688) on the video source and ends.

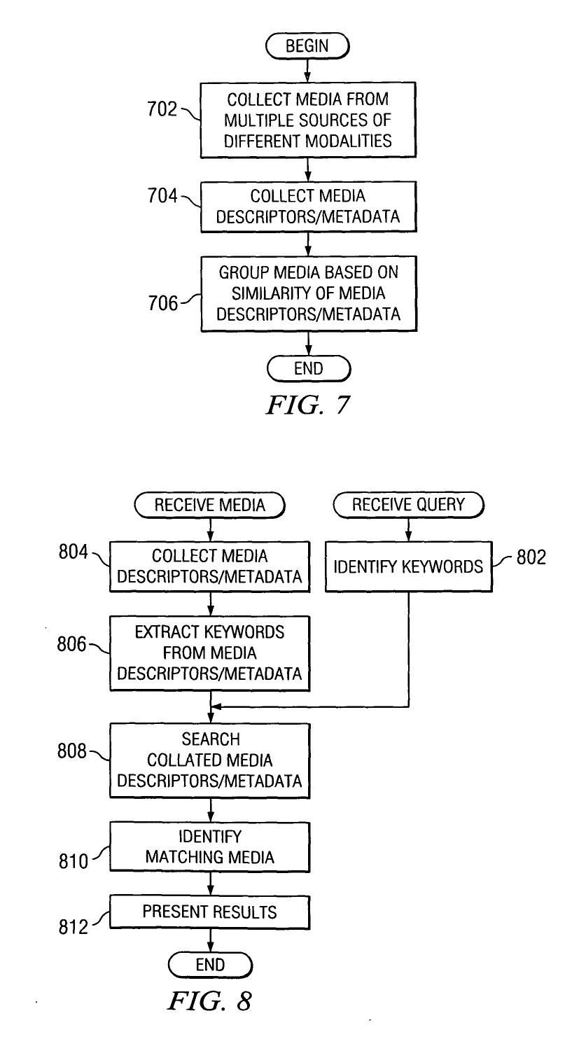

FIG. 7 is a flowchart illustrating the operation of an exemplary collation and analysis mechanism in accordance with exemplary aspects of the present invention. The process begins and collects media from multiple sources of different modalities (step 702). Then, the process collects media descriptors/metadata for the media sources (step 704). The process groups media based on similarity of media descriptors/metadata (step 706). Thereafter, the process ends.

Next, with reference to FIG. 8, a flowchart is shown illustrating the operation of an exemplary query processing and presentation module in accordance with exemplary aspects of the present invention. The process receives a query and identifies keywords (step 802). Then, the process searches collated media descriptors/metadata (step 808). Alternatively, the process receives a media source and collects media descriptors/metadata for the received media source (step 804). The process then extracts keywords from the media descriptors for the received media source (step 806) and searches collated media descriptors/metadata (step 808). The process then identifies matching media (step 810) and presents results (step 812). Thereafter, the process ends.

Thus, the exemplary aspects of the present invention at least solve the disadvantages of the prior art by, for example, providing a mechanism for cross-linking media sources of different modalities. Text documents, images, audio sources, video, and other media are analyzed to determine media descriptors, which are metadata describing the content of the media sources. The media descriptors from all modalities are collated and cross-linked. A query processing and presentation module, which receives queries and presents results, may also be provided. A query may consist of textual keywords from user input. Alternatively, a query may derive from a media source, such as a text document, image, audio source, or video source. By use of multiple modalities, the exemplary system of the present invention is able to infer relationships between information sources in a way that is not possible using a single modality such as text.

It is important to note that while the exemplary aspects of the present invention have been described in the context of a fully functioning data processing system, those of ordinary skill in the art will appreciate that the processes of the various exemplary embodiments of the present invention may be distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the various exemplary embodiments of the present invention has been presented for purposes of illustration and description, and is not intended to be exhaustive or limited to the invention in the form disclosed. Many modifications and variations will be apparent to those of ordinary skill in the art. The various exemplary embodiments were chosen and described in order to best explain the principles of the invention, the practical application, and to enable others of ordinary skill in the art to understand the invention for various embodiments with various modifications as are suited to the particular use contemplated.

1. A method for cross-linking information sources using multiple modalities, the method comprising:
receiving a plurality of media sources, wherein at least two media sources have different modalities;
performing media specific translation on the plurality of media sources to extract content information;
performing content analysis on the extracted content information to form media descriptors; and
cross-linking the plurality of media sources based upon the media descriptors.

2. The method of claim 1, wherein the step of performing media specific translation includes at least one of character recognition, speech recognition, voice recognition, image feature extraction, audio feature extraction, and motion feature extraction.

3. The method of claim 1, wherein the step of performing media specific translation includes extracting one of closed captioning information or subtitle information.

4. The method of claim 1, wherein the step of performing media specific translation includes performing frame capture of a video source.

5. The method of claim 1, further comprising:
receiving a query; and
searching the cross-linked media sources based on the media descriptors to identify at least one media source that matches the query.

6. The method of claim 5, wherein the query includes keywords.

7. The method of claim 5, wherein the query includes a query media source.

8. The method of claim 7, further comprising:
performing media specific translation on the query media source to extract query content information;
performing content analysis on the query content information to form query media descriptors; and
generating a query based on the query media descriptors.

9. The method of claim 1, wherein modalities of the plurality of media sources are selected from the group consisting of text, image, audio, and video.

10. An apparatus for cross-linking information sources using multiple modalities, the apparatus comprising:
a plurality of media sources, wherein at least two media sources have different modalities;
a plurality of media specific translation modules, wherein the media specific translation modules perform media specific translation on the plurality of media sources to extract content information; and
at least one analysis module, wherein the at least one analysis module performs content analysis on the extracted content information to form media descriptors and cross-links the plurality of media sources based upon the media descriptors.

11. The apparatus of claim 10, wherein the plurality of media specific translation modules include at least one of a character recognition module, a speech recognition module, a voice recognition module, an image feature extraction module, an audio feature extraction module, and a motion feature extraction module.

12. The apparatus of claim 10, wherein at least one of the plurality of media specific translation modules extracts one of closed captioning information or subtitle information.

13. The apparatus of claim 10, wherein at least one of the plurality of media specific translation modules performs frame capture of a video source.

14. The apparatus of claim 10, further comprising:
a query processing and presentation module, wherein the query processing and presentation module receives a query and searches the cross-linked media sources based on the media descriptors to identify at least one media source that matches the query.

15. The apparatus of claim 14, wherein the query includes keywords.

16. The apparatus of claim 14, wherein the query includes a query media source.

17. The apparatus of claim 16, wherein the query processing and presentation module performs media specific translation on the query media source to extract query content information, performs content analysis on the query content information to form query media descriptors, and generates a query based on the query media descriptors.

18. The apparatus of claim 10, wherein modalities of the plurality of media sources are selected from the group consisting of text, image, audio, and video.

19. A computer program product, in a computer readable medium, for cross-linking information sources using multiple modalities, the computer program product comprising:
instructions for receiving a plurality of media sources, wherein at least two media sources have different modalities;
instructions for performing media specific translation on the plurality of media sources to extract content information;
instructions for performing content analysis on the extracted content information to form media descriptors; and
instructions for cross-linking the plurality of media sources based upon the media descriptors.

20. The computer program product of claim 19, further comprising:
instructions for receiving a query; and
instructions for searching the cross-linked media sources based on the media descriptors to identify at least one media source that matches the query.
